(19) United States
(12) Patent Application Publication
(10) Pub. No.: US 2020/0006855 A1
(43) Pub. Date: Jan. 2, 2020

(54) RADIO COMMUNICATION DEVICE

(71) Applicant: SHARP KABUSHIKI KAISHA, Sakai City (JP)

(72) Inventors: TAKAHIRO TABATA, Sakai City (JP); AKIHIRO IRIYAMA, Sakai City (JP); MIKIO KURAMOTO, Sakai City (JP); NOZOMU HIKINO, Sakai City (JP); HIDEAKI AONO, Sakai City (JP); KOTA SATO, Sakai City (JP)

(21) Appl. No.: 16/453,399

(22) Filed: Jun. 26, 2019

(30) Foreign Application Priority Data
Jun. 29, 2018 (JP) 2018-125220

(51) Int. Cl. H01Q 9/04; H01Q 1/38

(52) U.S. Cl. CPC H01Q 9/0421; H01Q 1/38; H01Q 9/045

(57) ABSTRACT

The present invention provides a radio communication device (100) in which two antennas is arranged in the same location. The radio communication device (100) includes a first antenna (4) and a second antenna (7). A second conductor element (8) of the second antenna is configured to overlap with a first conductor element (5) of the first antenna. The second antenna is configured to employ, as a second ground plate (9), the first conductor element of the first antenna. A wiring section (10) of the second antenna is configured to pass through a path that overlaps with a short-circuit section (S) of the first antenna.

This Nonprovisional application claims priority under 35 U.S.C. § 119 on Patent Application No. 2018-125220 filed in Japan on Jun. 29, 2018, the entire contents of which are hereby incorporated by reference.

### TECHNICAL FIELD

The present invention relates to a radio communication device.

### BACKGROUND ART

A technique is known which can simplify a structure of, reduce the size of, and achieve weight saving of a configuration including composite two antennas. For example, Patent Literature 1 discloses a configuration in which a patch antenna and an inverted F antenna are provided adjacent to each other so that elements of the two antennas do not overlap each other.

### CITATION LIST

### Patent Literature

[Patent Literature 1]

Japanese Patent Application Publication Tokukai No. 2017-063255

### SUMMARY OF INVENTION

### Technical Problem

However, in a case where the two antennas are identical in their optimal locations, only one of the two antennas can be provided in such an optimal location. This causes a problem that the other of the two antennas deteriorates its performance.

In view of the problem, an object of an aspect of the present invention is to provide a radio communication device in which two antennas are provided in a single location.

### Solution to Problem

In order to solve the above problem, a radio communication device in accordance with an aspect of the present invention includes: (i) a first antenna including a first conductor section and a short-circuit section; and (ii) a second antenna including a second conductor section and a signal line, the second conductor section being configured to overlap with the first conductor section, the second antenna being configured to employ, as a ground section, the first conductor section, and the signal line being configured to pass through a path that overlaps with the short-circuit section.

### Advantageous Effects of Invention

With the configuration of such an aspect of the present invention, it is possible to provide a radio communication device in which two antennas are provided in a single location.

### BRIEF DESCRIPTION OF DRAWINGS

FIG. 1 is an explanatory view illustrating how (i) an antenna of a radio communication device and (ii) a periphery of the antenna in accordance with Embodiment 1 of the present invention are configured.

FIG. 2 is an explanatory view illustrating how (i) an antenna of a radio communication device in accordance with Embodiment 2 of the present invention and (ii) a periphery of the antenna are configured.

FIG. 3 is an explanatory view illustrating how (i) an antenna of a radio communication device in accordance with Embodiment 3 of the present invention and (ii) a periphery of the antenna are configured.

FIG. 4 is an explanatory view illustrating how (i) an antenna of a radio communication device in accordance with Embodiment 4 of the present invention and (ii) a periphery of the antenna are configured.

FIG. 5 is an explanatory view illustrating how (i) an antenna of a radio communication device in accordance with Embodiment 5 of the present invention and (ii) a periphery of the antenna are configured.

FIG. 6 is an explanatory view illustrating how (i) an antenna of a radio communication device in accordance with Embodiment 6 of the present invention and (ii) a periphery of the antenna are configured.

FIG. 7 is an explanatory view illustrating how (i) an antenna of a radio communication device in accordance with Embodiment 7 of the present invention and (ii) a periphery of the antenna are configured.

FIG. 8 is an explanatory view illustrating how (i) an antenna of a radio communication device in accordance with Embodiment 8 of the present invention and (ii) a periphery of the antenna are configured.

FIG. 9 is an explanatory view illustrating how (i) an antenna of a radio communication device in accordance with Embodiment 8 of the present invention and (ii) a periphery of the antenna are configured.

FIG. 10 is an explanatory view illustrating how (i) an antenna of a radio communication device in accordance with Embodiment 9 of the present invention and (ii) a periphery of the antenna are configured.

### DESCRIPTION OF EMBODIMENTS

### Embodiment 1

The following description will discuss, in detail, Embodiment 1 of the present invention.

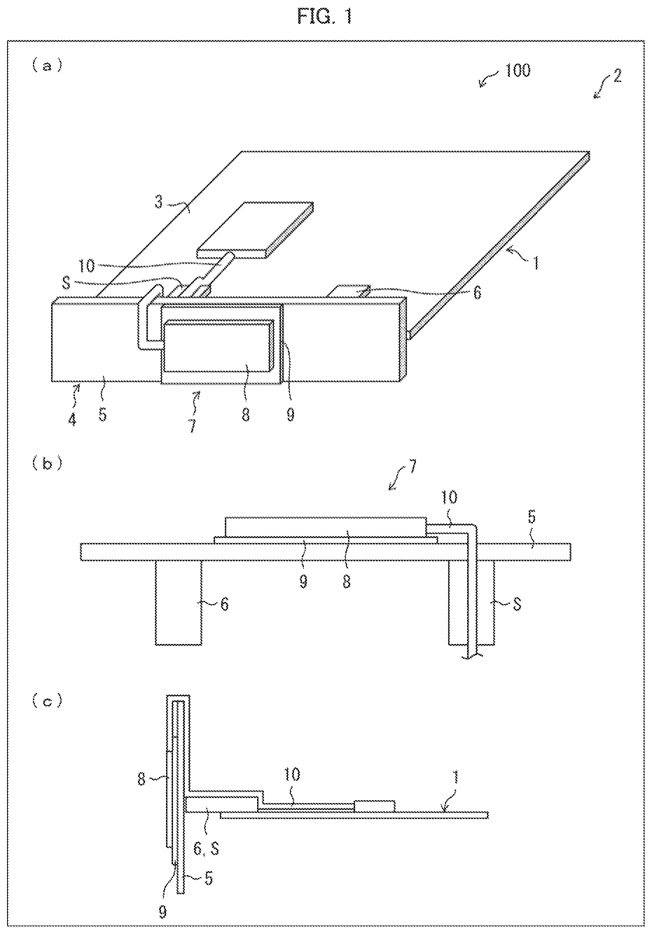

FIG. 1 is an explanatory view illustrating how (i) an antenna and (ii) a periphery of a radio communication device 100 in accordance with Embodiment 1 of the present invention are configured. (a) of FIG. 1 illustrates how (i) a first antenna 4, (ii) a second antenna 7 and its periphery are configured. (b) of FIG. 1 illustrates a cross-sectional view of the second antenna 7.

The radio communication device 100 includes a casing 2 in which a first substrate (substrate) 1 is provided. The casing 2 includes a first ground plate 3. The radio communication device 100 further includes the first antenna 4 and the second antenna 7.

As illustrated in (a) of FIG. 1, the first antenna 4 is an inverted F antenna that includes a conductor element (first conductor section) 5, a power supply section 6, and a short-circuit section S. The conductor element 5 functions as an antenna element, and is fed by the power supply section 6. The conductor element 5 is connected to the first ground plate 3 via the short-circuit section S. The feed section 6 is connected to a radio circuit of the first substrate 1 so as to supply electric power to the conductor element 5. The short-circuit section S is connected to the first ground plate 3. Note that the first antenna 4 can be an antenna other than the inverted F antenna.

As illustrated in (a) of FIG. 1, the second antenna 7 is a patch antenna that includes (i) a conductor element (second conductor section) 8 connected to a wiring section (signal line) 10 and (ii) a second ground plate (ground section) 9. Electric power is supplied to the conductor element 8, via the wiring section 10. The second ground plate 9 is provided so as to be opposite to the conductor element 8. The wiring section 10 is connected to the radio circuit of the first substrate 1 so as to feed electric power to the conductor element 8.

As illustrated in (b) of FIG. 1, the conductor element 8 of the second antenna 7 is provided so as to overlap with the conductor element 5 of the first antenna 4. The second ground plate 9 of the second antenna 7 is provided so as to overlap with the conductor element 5 of the first antenna 4. The second ground plate 9 and the conductor element 5 can be capacitive-coupled or electrically connected to each other. The conductor element 8 of the second antenna 7 is provided so as to overlap with the second ground plate 9.

As illustrated in (a) and (b) of FIG. 1, the wiring section 10 of the second antenna 7 passes through a path that overlaps with the short-circuit section S of the first antenna 4. In other words, the wiring section 10 of the second antenna 7 is provided so as to overlap with (i) the conductor element 5 of the first antenna 4 and (ii) the short-circuit section S. The short-circuit section S serves as a path through which the wiring section 10 of the second antenna 7 passes. (i) The wiring section 10 and the conductor element 5 and (ii) the wiring section 10 and the short-circuit section S can be each capacitive-coupled or electrically connected to each other.

### Effects of Embodiment 1

With the configuration of Embodiment 1, in the radio communication device 100, the second ground plate 9 of the second antenna 7 is integrated with the conductor element 5 of the first antenna 4. As such, the second antenna 7 can be provided on the first antenna 4, instead of being affected by an electrical configuration of the first antenna 4.

Furthermore, the wiring section 10 of the second antenna 7 is integrated with the short-circuit section S of the first antenna 4. As such, the second antenna 7 can be provided on the first antenna 4, instead of affecting the electrical configuration of the first antenna 4. That is, the first antenna 4 is not electrically affected by the electrical configuration of the second antenna 7.

With the configuration, the first antenna 4 and the second antenna 7 can be provided in a single location. It follows that optimum provision is realized for both of the first and second antennas.

### Embodiment 2

The following description will discuss Embodiment 2 of the present invention. Note that, for convenience, members having identical functions to those of Embodiment 1 are given identical reference signs, and their descriptions will be omitted.

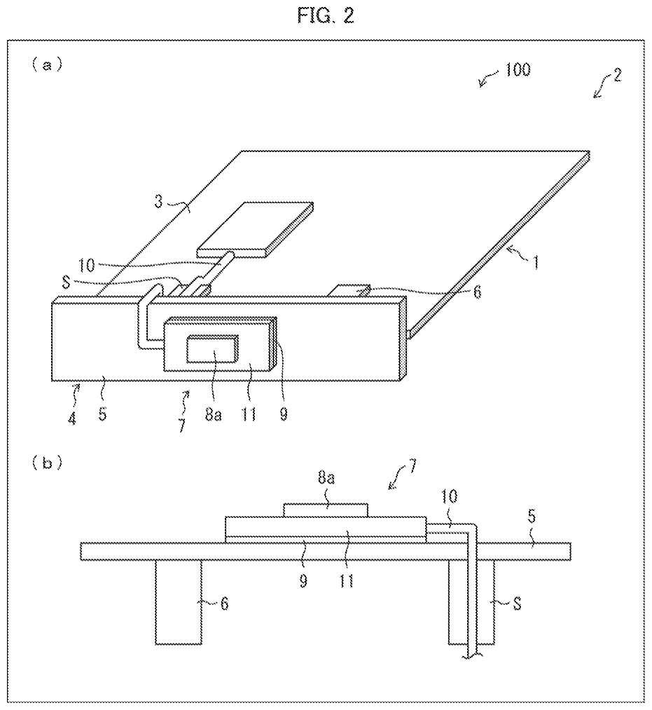

FIG. 2 is an explanatory view illustrating how (i) an antenna of a radio communication device 100 in accordance with Embodiment 2 and (ii) a periphery of the antenna are configured. (a) of FIG. 2 illustrates how a first antenna 4, a second antenna 7, and a periphery of the second antenna 7 are configured. (b) of FIG. 2 is a cross-sectional view of the second antenna 7.

The second antenna 7 is a patch antenna. The second antenna 7 further includes a second substrate 11 in addition to the configuration of Embodiment 1. According to the second antenna 7, the second antenna 7 employs, as a ground section, (i) a second ground plate 9 of the second substrate 11 and (ii) a conductor element 5 of the first antenna 4. As such, the second antenna 7 is configured so that a patch element (conductor section) 8a of the second antenna 7 overlaps, in parallel, with the second ground plate 9 of the second substrate 11. As illustrated in (a) and (b) of FIG. 2, the patch element 8a and the second ground plate 9 are formed, on respective surfaces of the second substrate 11, by respective conductor patterns (e.g., planar copper foils).

### Effects of Embodiment 2

With the configuration of Embodiment 2, since the second antenna 7 is such a patch antenna, the second antenna 7 can be short in height. It is therefore possible for the antenna characteristics of the first antenna 4 to be less affected by the second antenna 7.

### Embodiment 3

The following description will discuss Embodiment 3 of the present invention. Note that, for convenience, members having identical functions to those of Embodiment 2 are given identical reference signs and their descriptions will be omitted. According to Embodiment 3, a configuration in which a radio signal processing section (radio circuit) 12 is added to the radio communication device 100 as has been discussed in Embodiment 2.

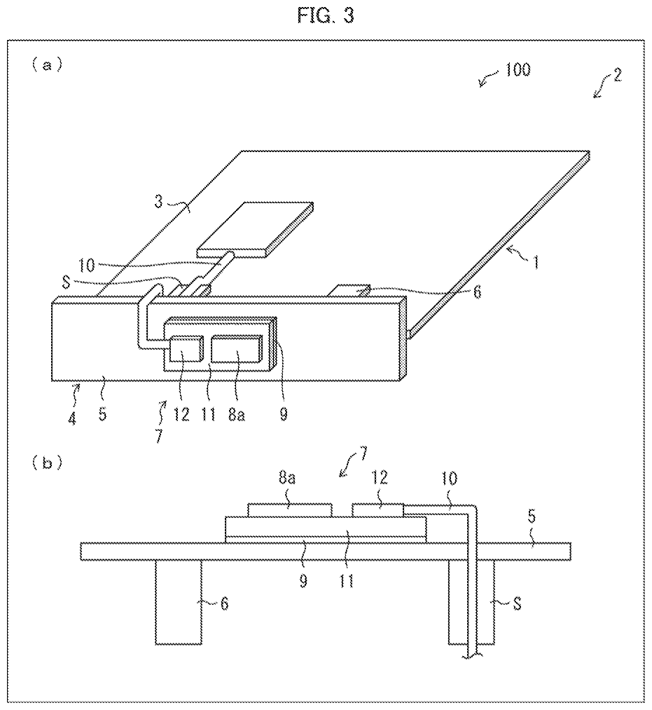

FIG. 3 is an explanatory view illustrating how (i) an antenna of a radio communication device 100 in accordance with Embodiment 3 of the present invention and (ii) a periphery of the antenna are configured. (a) of FIG. 3 illustrates how a first antenna 4, a second antenna 7, and a periphery of the second antenna 7 are configured. (b) of FIG. 3 is a cross-sectional view of the second antenna 7.

As illustrated in (a) and (b) of FIG. 3, the radio communication device 100 includes a radio signal processing section 12, in addition to the configuration of Embodiment 2. The radio signal processing section 12 is a radio circuit provided on a second substrate 11 so as to come close to a patch element 8a of the second antenna 7. The radio signal processing section 12 is connected to (i) the patch element 8a of the second antenna 7 and (ii) a first substrate 1 via a wiring section 10.

Note that the radio signal processing section 12 is covered with a shielding case. Note also that the radio signal processing section 12 is connected to the second substrate 11, for example, by use of a conductive double-sided tape or a conductive adhesive.

### Effects of Embodiment 3

With the configuration of Embodiment 3, the radio signal processing section 12 and the patch element 8a are provided so as to come close to each other. This allows a reduction in loss of signals that pass through between them. Furthermore, the signals, which pass through the wiring section 10, are controlled to have a lower frequency, and are then controlled, to have a higher frequency, by the radio signal processing section 12. This can facilitate signal processing in the wiring section 10.

### Embodiment 4

The following description will discuss Embodiment 4 of the present invention. Note that, for convenience, members having identical functions to those of Embodiment 2 are given identical reference signs and their descriptions will be omitted. According to Embodiment 4, a configuration in which a radio signal processing section 12 is added to the radio communication device 100 as has been discussed in Embodiment 2.

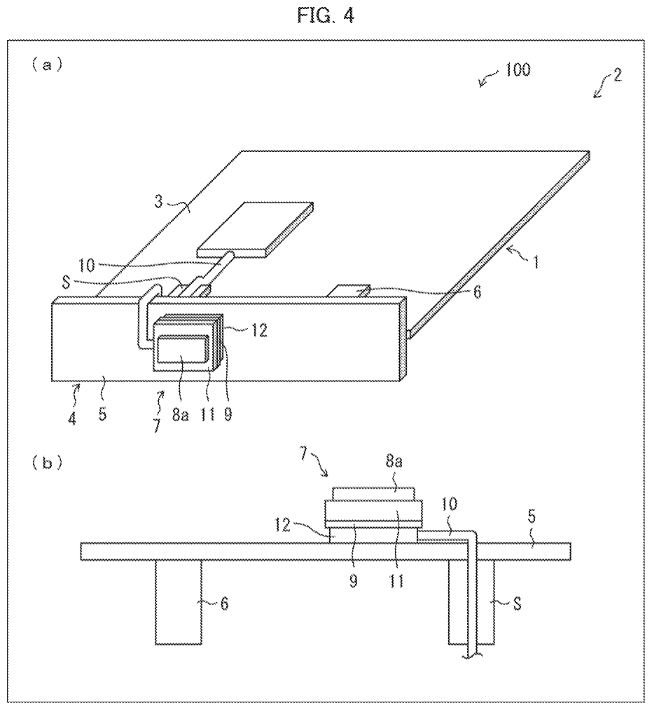

FIG. 4 is an explanatory view illustrating how (i) an antenna of a radio communication device 100 in accordance with Embodiment 3 of the present invention and (ii) a periphery of the antenna are configured. (a) of FIG. 4 illustrates how a first antenna 4, a second antenna 7, and a periphery of the second antenna 7 are configured. (b) of FIG. 4 is a cross-sectional view of the second antenna 7.

As illustrated in (a) and (b) of FIG. 4, the radio communication device 100 further includes the radio signal processing section (radio circuit) 12 in addition to the members described in Embodiment 2. The radio signal processing section 12 is a radio circuit which is provided on a second substrate 11. The radio signal processing section 12 is provided on the second ground plate 9 so as to be on the opposite side of a patch element 8a of the second antenna 7. In other words, the radio signal processing section 12 is provided between the second ground plate 9 of the second substrate 11 and a conductor element 5 of the first antenna 4. The radio signal processing section 12 is connected to (i) the patch element 8a of the second antenna 7 and (ii) a first substrate 1 via a wiring section 10.

Note that the radio signal processing section 12 is covered by a shield casing. The radio signal processing section 12 is connected to the conductor element 5 of the first antenna 4, via the shield casing.

### Effects of Embodiment 4

With the configuration of Embodiment 4, the second antenna 7 and the radio signal processing section 12 are provided so as to overlap each other. This allows a reduction in size of the second substrate 11 that constitutes the second antenna 7. This ultimately allows (i) a reduction in effects on the first antenna and (ii) heat, caused by the radio signal processing section 12, to be released via the conductor element 5 of the first antenna 4.

### Embodiment 5

The following description will discuss Embodiment 5 of the present invention. Note that, for convenience, members having identical functions to those of Embodiments 1 through 4 are given identical reference signs and their descriptions will be omitted.

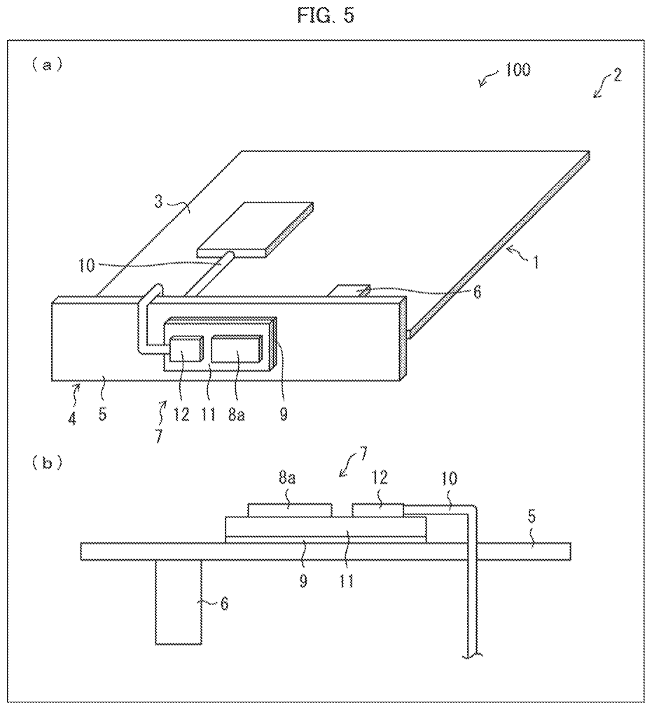

FIG. 5 is an explanatory view illustrating how (i) an antenna of a radio communication device 100 in accordance with Embodiment 5 and (ii) a periphery of the antenna are configured. (a) of FIG. 5 illustrates how a first antenna 4, a second antenna 7, and a periphery of the second antenna 7 are configured. (b) of FIG. 5 is a cross-sectional view of the second antenna 7.

A wiring section 10 of the second antenna 7 is integrated with a short-circuit section S of the first antenna 4. As illustrated in (a) and (b) of FIG. 5, the wiring section 10 of the second antenna 7 serves as the short-circuit section S of the first antenna 4.

### Effects of Embodiment 5

With the configuration of Embodiment 5, the wiring section 10 of the second antenna 7 is integrated with the short-circuit section S of the first antenna 4. This makes it easy to carry out wirings for the first antenna 4 and the second antenna 7.

### Embodiment 6

The following description will discuss Embodiment 6 of the present invention. Note that, for convenience, members having identical functions to those of Embodiments 1 through 5 are given identical reference signs and their descriptions will be omitted.

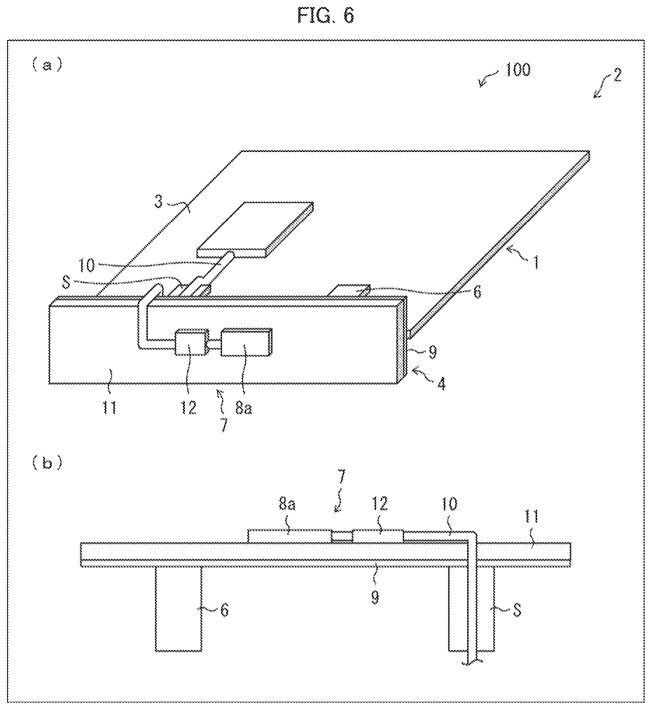

FIG. 6 is an explanatory view illustrating how (i) an antenna of a radio communication device 100 in accordance with Embodiment 6 of the present invention and (ii) a periphery of the antenna are configured. (a) of FIG. 6 illustrates how a first antenna 4, a second antenna 7, and a periphery of the second antenna 7 are configured. (b) of FIG. 6 is a cross-sectional view of the second antenna 7.

The second antenna 7 employs, as a second ground plate 9, a conductor element of the first antenna 4. As illustrated in (a) and (b) of FIG. 6, the conductor element of the first antenna 4 is integrated with the second ground plate 9 of the second antenna 7.

### Effects of Embodiment 6

With the configuration of Embodiment 6, the second antenna 7 employs, as the second ground plate 9, the conductor element of the first antenna 4. This causes members for the conductor element to be cut down. This ultimately eliminates a member for electrically connecting the conductor element and the second ground plate 9.

### Embodiment 7

The following description will discuss Embodiment 7 of the present invention. Note that, for convenience, members having identical functions to those of Embodiments 1 and 2 are given identical reference signs and their descriptions will be omitted.

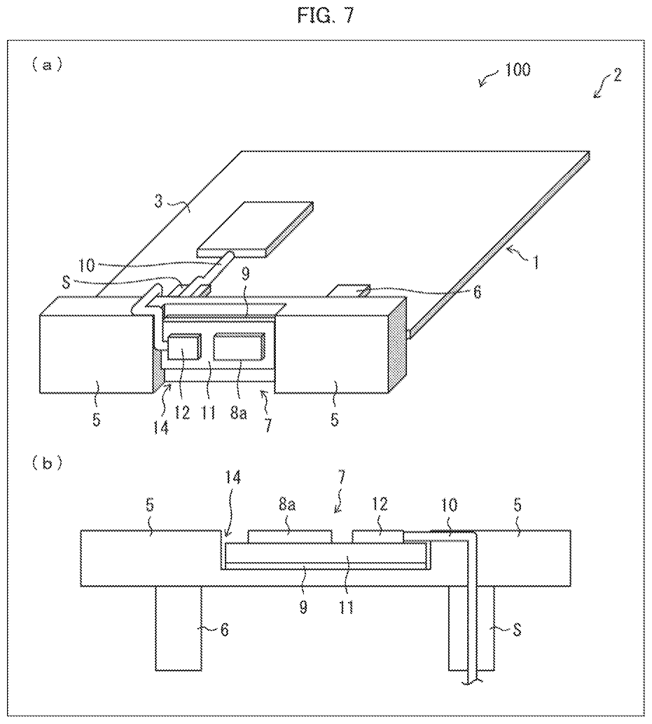

FIG. 7 is an explanatory view illustrating how (i) an antenna of a radio communication device 100 in accordance with Embodiment 7 of the present invention and (ii) a periphery of the antenna are configured. (a) of FIG. 7 illustrates how (i) a first antenna 4, (ii) a second antenna 7, and (iii) a periphery of the second antenna 7 are configured. (b) of FIG. 7 is a cross-sectional view of the second antenna 7.

As illustrated in (a) and (b) of FIG. 7, a conductor element 5 of the first antenna 4 has a recess 14 in which the second antenna 7 is placed.

### Effects of Embodiment 7

With the configuration of Embodiment 7, in a case where (i) the first antenna 4 is provided near an outer edge of the radio communication device 100 or (ii) the first antenna 4 is configured by an exterior part(s) of the radio communication device 100, the second antenna 7 can be arranged instead of causing an exterior appearance of the radio communication device 100 to project.

### Embodiment 8

The following description will discuss Embodiment 8 of the present invention. Note that, for convenience, members having identical functions to those of Embodiments 1 and 2 are given identical reference signs and their descriptions will be omitted.

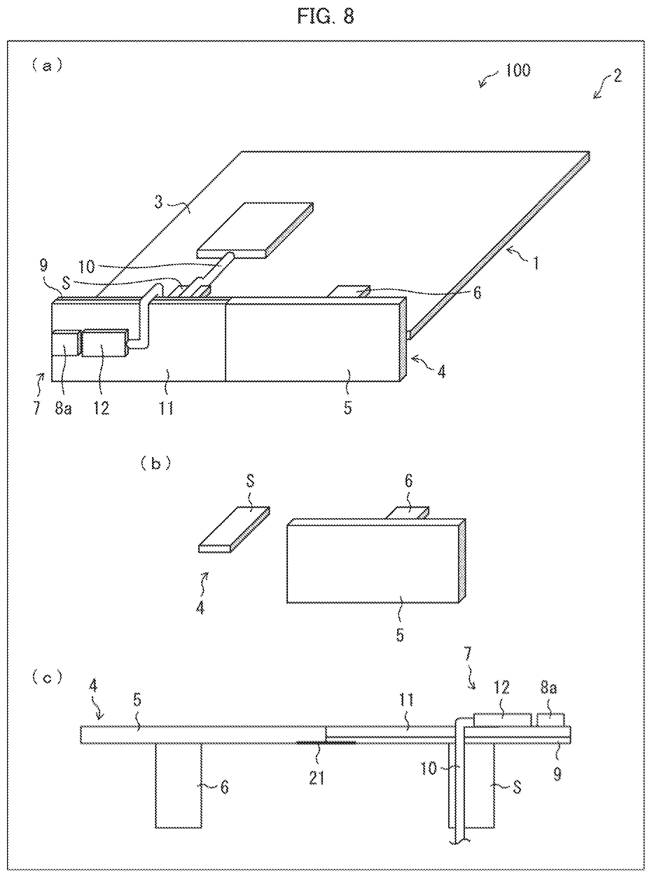

FIG. 8 is an explanatory view illustrating how (i) an antenna of a radio communication device 100 in accordance with Embodiment 8 of the present invention and (ii) a periphery of the antenna are configured. (a) of FIG. 8 illustrates how a first antenna 4, a second antenna 7, and a periphery of the second antenna 7 are configured. (b) of FIG. 8 illustrates how the first antenna 4 is configured. (c) of FIG. 8 is a cross-sectional view of the second antenna 7.

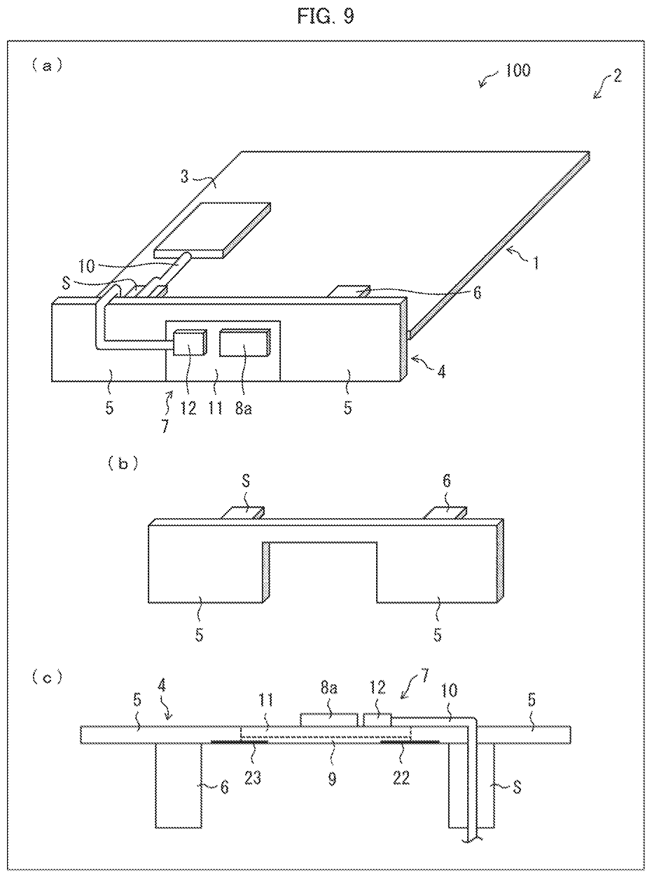

FIG. 9 is an explanatory view illustrating how (i) an antenna of a radio communication device 100 in accordance with Embodiment 9 of the present invention and (ii) a periphery of the antenna are configured. (a) of FIG. 9 illustrates how the first antenna 4, the second antenna 7, and a periphery of the second antenna 7 are configured. (b) of FIG. 9 illustrates how the first antenna 4 is configured. (c) of FIG. 9 is a cross-sectional view of the second antenna 7.

For example, a thin copper foil is employed as a patch element 8a. As such, (i) the patch element 8a of the second antenna 7 and (ii) a conductor element 5 of the first antenna 4 are arranged so as to be on the same level.

As illustrated in (a) of FIG. 8, the first antenna 4 and the second antenna 7 can be arranged so as to be adjacent to each other. In such an arrangement, as illustrated in (c) of FIG. 8, the conductor element 5 of the first antenna 4 is electrically connected with a second ground plate 9 of the second antenna 7, via a conductor 21.

As illustrated in (a), (b), and (c) of FIG. 9, the second antenna 7 can be alternatively sandwiched between parts of the first antenna 4. In such an arrangement, the conductor element 5, located on a right side of the first antenna 4, is electrically connected to the second ground plate 9 of the second antenna 7, via a conductor 22 (see (c) of FIG. 9). Similarly, the conductor element 5, located on a left side of the first antenna 4, is electrically connected to the second ground plate 9 of the second antenna 7, via a conductor 23.

Note that it is only necessary that the conductor element 5 of the first antenna 4 and the second ground plate 9 of the second antenna 7 are electrically connected. As such, the conductor element 5 and the second ground plate 9 can be electrically connected in a manner different than the above manner.

### Effects of Embodiment 8

With the configuration of Embodiment 8, the first antenna 4 and the second antenna 7 can be arranged so as to be on the same level, while securing a spaced distance between (i) a ground plate in the radio communication device 100 and (ii) the first antenna 4. This makes it possible to (i) prevent the first antenna 4 from deteriorating its performance and (ii) arrange the second antenna 7 instead of causing an exterior appearance of the radio communication device 100 to project.

### Embodiment 9

The following description will discuss Embodiment 9 of the present invention. Note that, for convenience, members having identical functions to those of Embodiments 1 through 8 are given identical reference signs and their descriptions will be omitted.

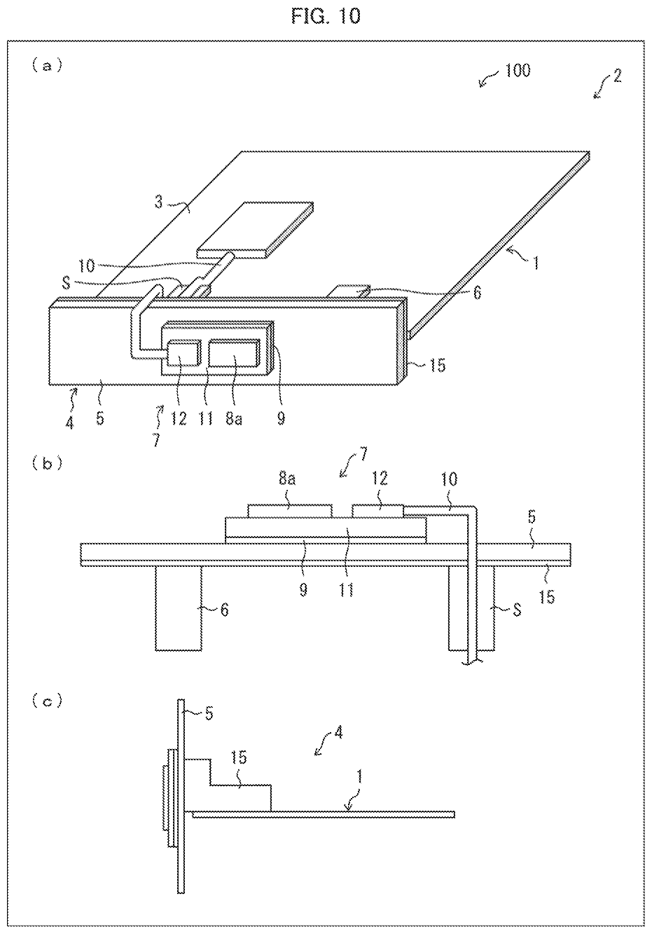

FIG. 10 is an explanatory view illustrating how (i) an antenna of a radio communication device in accordance with Embodiment 10 of the present invention and (ii) a periphery of the antenna are configured. (a) of FIG. 10 illustrates how a first antenna 4, a second antenna 7, and a periphery of the second antenna 7 are configured. (b) of FIG. 10 is a cross-sectional view of the second antenna 7. (c) of FIG. 10 is a cross-sectional view of the first antenna 4.

The radio communication device 100 further includes a heat radiation sheet (heat radiating section) 15. The heat radiation sheet 15 is made of, for example, a gelatinous substance or silicon. The heat radiation sheet 15 is provided between (i) a conductor element 5 of the first antenna 4 and (ii) either a first substrate 1 or a casing 2 of the radio communication device 100 (see (a), (b), and (c) of FIG. 10).

### Effects of Embodiment 9

With the configuration of Embodiment 9, it is possible to lead heat, which is generated by a radio signal processing section 12 of the second antenna 7, to a large metallic member. This causes the heat thus generated to be radiated. Examples of the large metallic member encompass a ground of the first substrate 1 or a first ground plate 3 of the casing 2.

[Recap]

A radio communication device in accordance with a first aspect of the present invention includes: (i) a first antenna including a first conductor section and a short-circuit section; and (ii) a second antenna including a second conductor section and a signal line, the second conductor section being configured to overlap with the first conductor section, the second antenna being configured to employ, as a ground section, the first conductor section, and the signal line being configured to pass through a path that overlaps with the short-circuit section.

In a second aspect of the present invention, the radio communication device can be configured such that, in the first aspect, the second antenna is a patch antenna, the second antenna includes a substrate, the second antenna employs, as a ground section, (i) a ground of the substrate and (ii) the first conductor section, and the second conductor section and the ground of the substrate are configured to overlap each other in parallel.

In a third aspect of the present invention, the radio communication device can be configured such that, in the second aspect, a radio circuit that is to be connected to the second conductor section is further included, the radio circuit being arranged so as to come, on the substrate, close to the second conductor section.

In a fourth aspect of the present invention, the radio communication device can be configured so that, in the second aspect, a radio circuit that is connected to the second conductor section is further included, the radio circuit being provided, on the ground section, so as to be opposite to the second conductor section.

In a fifth aspect of the present invention, the radio communication device can be configured such that, in any one of the first through fourth aspects, the short-circuit section of the first antenna is composed of the signal line of the second antenna.

In a sixth aspect of the present invention, the radio communication device can be configured such that, in the first or second aspect, the first conductor section has a recess, and

the second antenna is placed in the recess.

In a seventh aspect of the present invention, the radio communication device can be configured such that, in the first or second aspect, the first conductor section and the second conductor section are arranged so as to be on the same level.

In an eighth aspect of the present invention, the radio communication device can be configured such that, in the first or second aspect, a heat radiating section is further included, the heat radiating section being provided between (i) the first conductor section and (ii) either a substrate or a casing of the radio communication device.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

100 Radio communication device
1 First substrate (substrate)
2 Casing
3 First ground plate
4 First antenna
5 Conductor element (first conductor section)
S Short-circuit section
7 Second antenna
8 Conductor element (second conductor section)
8a Patch element (second conductor section)
9 Second ground plate (ground section)
10 Wiring section (signal line)
11 Second substrate (substrate)
12 Radio signal processing section (radio circuit)
14 Recess
15 Heat radiation sheet (heat radiating section)

1. A radio communication device, comprising:
a first antenna including a first conductor section and a short-circuit section; and
a second antenna including a second conductor section and a signal line,
the second conductor section being configured to overlap with the first conductor section,
the second antenna being configured to employ, as a ground section, the first conductor section, and
the signal line being configured to pass through a path that overlaps with the short-circuit section.

2. The radio communication device as set forth in claim 1, wherein:
the second antenna is a patch antenna,
the second antenna includes a substrate,
the second antenna employs, as a ground section, (i) a ground of the substrate and (ii) the first conductor section, and
the second conductor section and the ground of the substrate are configured to overlap each other in parallel.

3. A radio communication device as set forth in claim 2, further comprising a radio circuit that is to be connected to the second conductor section,
the radio circuit being arranged so as to come, on the substrate, close to the second conductor section.

4. A radio communication device as set forth in claim 2, further comprising a radio circuit that is connected to the second conductor section,
the radio circuit being provided, on the ground section, so as to be opposite to the second conductor section.

5. The radio communication device as set forth in claim 1, wherein the short-circuit section of the first antenna is composed of the signal line of the second antenna.

6. The radio communication device as set forth in claim 1, wherein:
the first conductor section has a recess; and
the second antenna is placed in the recess.

7. The radio communication device as set forth in claim 1, wherein the first conductor section and the second conductor section are arranged so as to be on the same level.

8. A radio communication device as set forth in claim 1, further comprising a heat radiating section,
the heat radiating section being provided between (i) the first conductor section and (ii) either a substrate or a casing of the radio communication device.

9. The radio communication device as set forth in claim 2, wherein the short-circuit section of the first antenna is composed of the signal line of the second antenna.

10. The radio communication device as set forth in claim 2, wherein:
the first conductor section has a recess; and
the second antenna is placed in the recess.

11. The radio communication device as set forth in claim 2, wherein the first conductor section and the second conductor section are arranged so as to be on the same level.

12. A radio communication device as set forth in claim 2, further comprising a heat radiating section,
the heat radiating section being provided between (i) the first conductor section and (ii) either a substrate or a casing of the radio communication device.

13. The radio communication device as set forth in claim 3, wherein the short-circuit section of the first antenna is composed of the signal line of the second antenna.

14. The radio communication device as set forth in claim 4, wherein the short-circuit section of the first antenna is composed of the signal line of the second antenna.
